(19) United States
(12) Patent Application Publication
(10) Pub. No.: US 2018/0370462 A1
(43) Pub. Date: Dec. 27, 2018

(54) ELECTRIC POWER DISTRIBUTION MODULE AND SYSTEM

(71) Applicant: iCONN SYSTEMS, LLC, Lombard, IL (US)

(72) Inventors: Richard M. Regole, JR., Glen Ellyn, IL (US); Anthony S. Czyz, Schaumburg, IL (US); John P. Regole, Chicago, IL (US)

(21) Appl. No.: 15/679,921

(22) Filed: Aug. 17, 2017

Related U.S. Application Data
(60) Provisional application No. 62/525,574, filed on Jun. 27, 2017.

(51) Int. Cl. B60R 16/023; H02B 1/20; H02G 3/08; H02B 1/46

(52) U.S. Cl. CPC B60R 16/0238; B60R 16/0239; H02B 1/056; H02G 3/08; H02B 1/46; H02B 1/202

(57) ABSTRACT

According to one aspect, an electric power distribution module comprises a housing having an opening. A substrate is disposed in the housing and an electrical conductor is disposed on the substrate. An edge portion of the substrate proximate the opening is adapted to receive and electrically connect a connector from outside the housing through the opening to the conductor.

### CROSS REFERENCE TO RELATED APPLICATIONS

The present application claims the benefit of Regole et al., U.S. provisional patent application Ser. No. 62/525,574, filed on Jun. 27, 2017, and entitled “Electric Power Distribution Module and System.” The entire contents of this application are hereby incorporated herein by reference.

### FIELD OF DISCLOSURE

The present subject matter relates to an apparatus for distributing electric power.

### BACKGROUND

In some items, such as cabinets for use in, for example, kitchens or the like, or in furniture or other items there may be a need to provide electric power to one or more devices, such as lighting, located in the item. At times, the item containing the device(s) may be located remotely from a source of electric power. Thus, for example, a plurality of kitchen cabinets may be located near to or adjacent to one another and a driver circuit disposed in or adjacent one of the cabinets develops low voltage DC power from 110 volt AC utility power for LED lights and/or other low voltage electric loads in the cabinets. Some provision must be made in such an arrangement to deliver the low voltage power to the LED lights and/or other loads in the cabinets from the driver circuit.

In prior arrangements such as the foregoing, there was often a need to run separate wires between the driver circuit and the individual loads or groups of loads to prevent voltage drops occurring in one load or group of loads from adversely affecting the operation of other loads or load groups. Thus, the installer had to measure, cut, strip, mount, and interconnect multiple wires between the driver circuit and the loads, resulting in an unsightly and labor-intensive installation that was costly.

Kitchen and other cabinet manufacturers are currently looking to integrate low voltage wiring systems into their cabinets to facilitate LED lighting and other applicable low voltage power accessories. The intent is that the wiring or bussing system will be installed by the factory eliminating the need for custom installations by the consumer. However, two problems arise in such an arrangement. First, due to the geometry of standard cabinetry, the wiring system needs to be fitted with connectors within each cabinet and between adjacent cabinets after cabinet installation. Also, due to the nature of low voltage DC wiring, the voltage drop across long lines of wire needs to be minimized; otherwise, the LED drivers powering the lights cannot function. This places a limit on the overall length and/or AWG size of the wiring system.

### SUMMARY

According to one aspect, an electric power distribution module comprises a housing having an opening. A substrate is disposed in the housing and an electrical conductor is disposed on the substrate. An edge portion of the substrate proximate the opening is adapted to receive and electrically connect a connector from outside the housing through the opening to the conductor.

According to another aspect, an electric power distribution module includes a housing enclosing a circuit board and having an opening that permits access to an edge of the circuit board. A conductor is disposed on the circuit board proximate the edge thereof wherein the conductor is exposed through the opening. A connector plug extends through the opening and includes two portions with a recess therebetween adapted to receive the edge of the circuit board and an electrical contact extending into the recess such that the connector plug is retained in the opening and the edge of the circuit board is disposed in the recess with the conductor electrically coupled to the contact.

According to yet another aspect, an electric power distribution system, comprises a plurality of distribution modules wherein at least one distribution module is electrically connected to another distribution module by at least one first conductor and first and second connector plugs disposed at opposite ends of the at least one first conductor. Further, at least one of the distribution modules is adapted to be coupled to a load by at least one second conductor having a third connector plug disposed at an end of the at least one second conductor. Each distribution module includes a housing having an opening, a circuit board disposed in the housing, and a plurality of electrically conductive traces disposed on opposite sides of the circuit board proximate the opening, wherein the opening is adapted to receive at least one of the first, second, and third conductor plugs.

Other aspects and advantages will become apparent upon consideration of the following detailed description and the attached drawings wherein like numerals designate like structures throughout the specification.

### BRIEF DESCRIPTION OF THE DRAWINGS

FIG. 1 is a block diagram of an exemplary embodiment of an electric power distribution system incorporating modules as disclosed herein;

FIG. 2 is an isometric view of an exemplary cable that may be used in the electric power distribution system of FIG. 1;

FIG. 3 is a fragmentary sectional isometric view of the cable taken generally along the lines 3-3 of FIG. 2;

FIG. 4 is an enlarged isometric view of first and second sides and a top side of the module 20 of FIG. 1;

FIG. 5 is an enlarged isometric view of third and fourth sides and the top side of the module 20 of FIG. 1;

FIG. 6 is an isometric view of a further exemplary embodiment of an electric power distribution system taken from the front thereof;

FIG. 7 is an isometric view of another exemplary cable that may be used in the electric power distribution system of FIG. 6;

FIG. 8 is an isometric view of a still further exemplary cable that may be used in the electric power distribution system of FIG. 6;

FIG. 8A is another isometric view of the still further exemplary cable of FIG. 8;

FIG. 9 is an enlarged fragmentary isometric view of the cable of FIG. 7;

FIG. 10 is an enlarged fragmentary isometric view with portions broken away of the connector plug of the cable of FIG. 7 taken from a first end thereof;

FIG. 11 is an enlarged fragmentary isometric view with portions broken away of the connector plug of the cable of FIG. 7 taken from a second end thereof;

FIG. 12 is an enlarged isometric view of two sides and a top side of a module 120a of FIG. 6;

FIG. 13 is an enlarged fragmentary isometric view of the connector plug of the cable of FIG. 7 and a substrate;

FIGS. 14, 15, and 27-30 are exploded isometric views of portions of the top and bottom portions of the electric power distribution system of FIG. 6;

FIG. 16 is a fragmentary isometric view of the cable of FIG. 8A connected to an exemplary load;

FIG. 17 is an isometric view of the top portion of the further exemplary embodiment of FIG. 6 taken from the rear and below and a first side thereof;

FIG. 18 is an isometric view of the top portion of the further exemplary embodiment of FIG. 6 taken from the rear and above and a second side thereof;

FIG. 18A is an isometric view of the top portion of the further exemplary embodiment of FIG. 6 taken from the rear and below and a second side thereof;

FIG. 19 is an exploded isometric view of a bottom portion of the further exemplary embodiment of FIG. 6 taken from the rear and below and a first side thereof;

FIG. 20 is an exploded isometric view of a bottom portion of the further exemplary embodiment of FIG. 6 taken from the rear and below and a second side thereof;

FIG. 21 is an exploded assembly view illustrating assembly of the top and bottom portions of the further exemplary embodiment of FIG. 6 into upper and lower or base cabinets;

FIG. 22 is an isometric view of the upper cabinet of FIG. 21 with the top portion of the further exemplary embodiment of FIG. 6 assembled therein;

FIG. 23 is an enlarged fragmentary isometric view from above of the cabinet of FIG. 22;

FIG. 24 is an enlarged fragmentary isometric view from below of the cabinet of FIG. 22 with portions broken away;

FIG. 25 is an enlarged fragmentary isometric view from below of the lower or base cabinet of FIG. 22 with the bottom portion of the further exemplary embodiment of FIG. 6 assembled therein; and

FIG. 26 is an enlarged fragmentary isometric view from above of the cabinet of FIG. 25.

### DETAILED DESCRIPTION

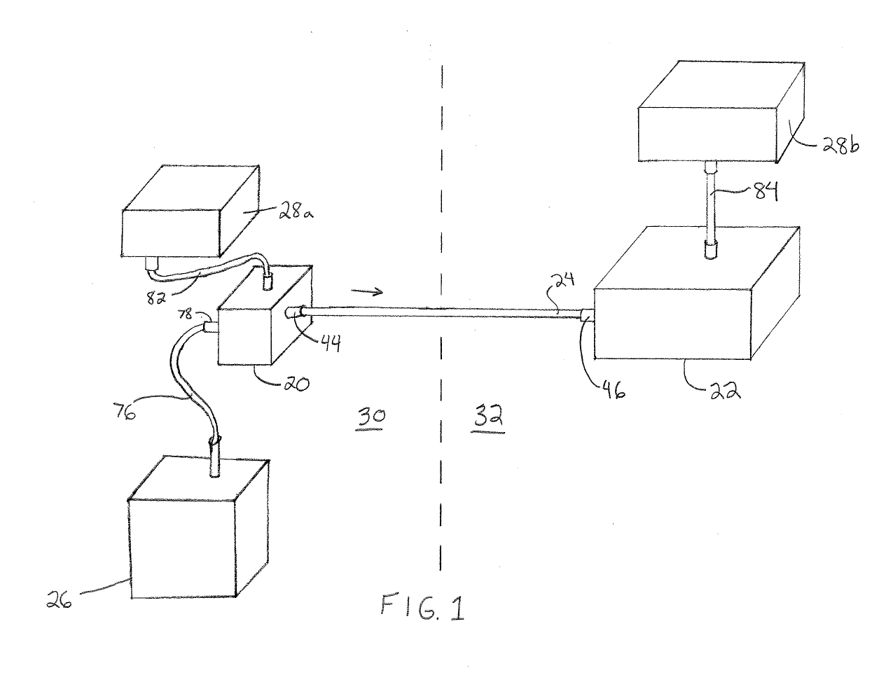

Referring first to FIG. 1, a first exemplary embodiment of an electric power distribution system includes a first electric power distribution module 20, a second electric power distribution module 22 that is substantially or completely identical to or different than the first module 20, and at least one cable 24 extending between the modules 20, 22. A driver circuit 26 converts 110 volt AC utility power into low voltage electric power, such as 12 volt DC power, which is supplied to at least one of the modules 20, 22 as described in greater detail hereinafter. One or more electric loads 28 are connected to one or both of the modules 20, 22 to receive power therefrom.

In a general sense, the modules may be located at or in different locations or at the same location and in or adjacent different items or structures or the same item or structure. Further, only one or more than two modules may be utilized to distribute electric power developed by the driver circuit 26 and/or another source or sources of power (not shown). Power may be supplied to one of the modules 20, 22 and transferred to the other module 22, 20. In a specific exemplary embodiment, the first module 20 is disposed in a first cabinet 30, the second module 22 is disposed in a second cabinet 32, the loads 28 comprise first and second groups or strings 28a, 28b of LEDs, the driver circuit 26 is coupled to the first module 20, and power delivered to the first module 20 by the driver circuit 26 is transferred to the second module 22 by the cable 24. The electric power delivered to the modules 20, 22 is, in turn, transferred by the modules 20, 22 to the strings of LEDs 28a, 28b, respectively.

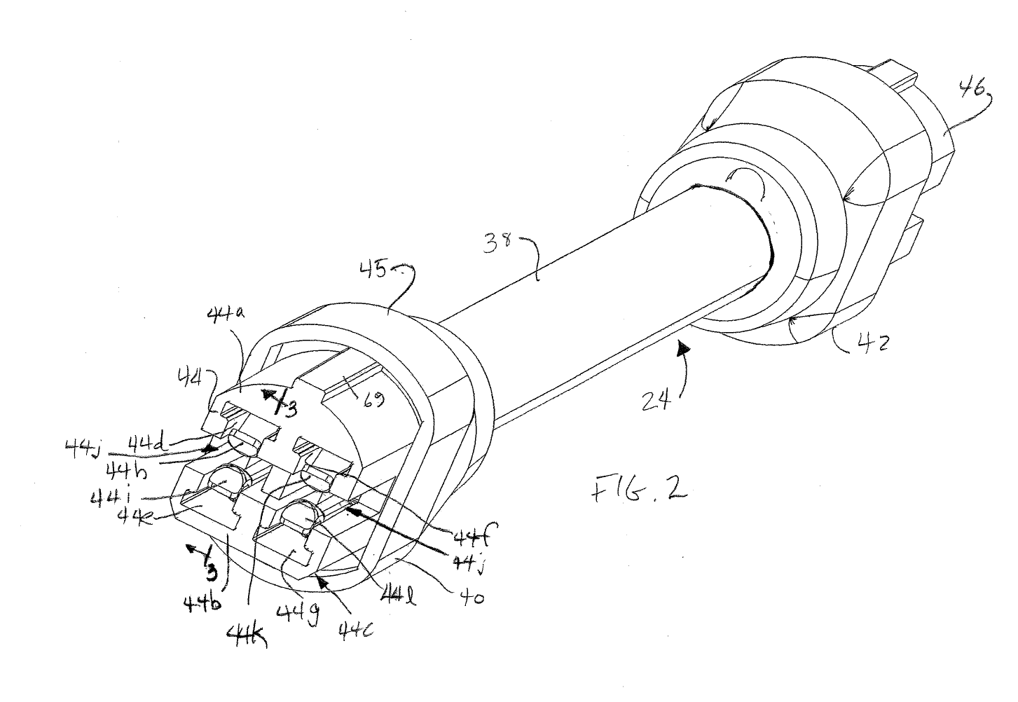

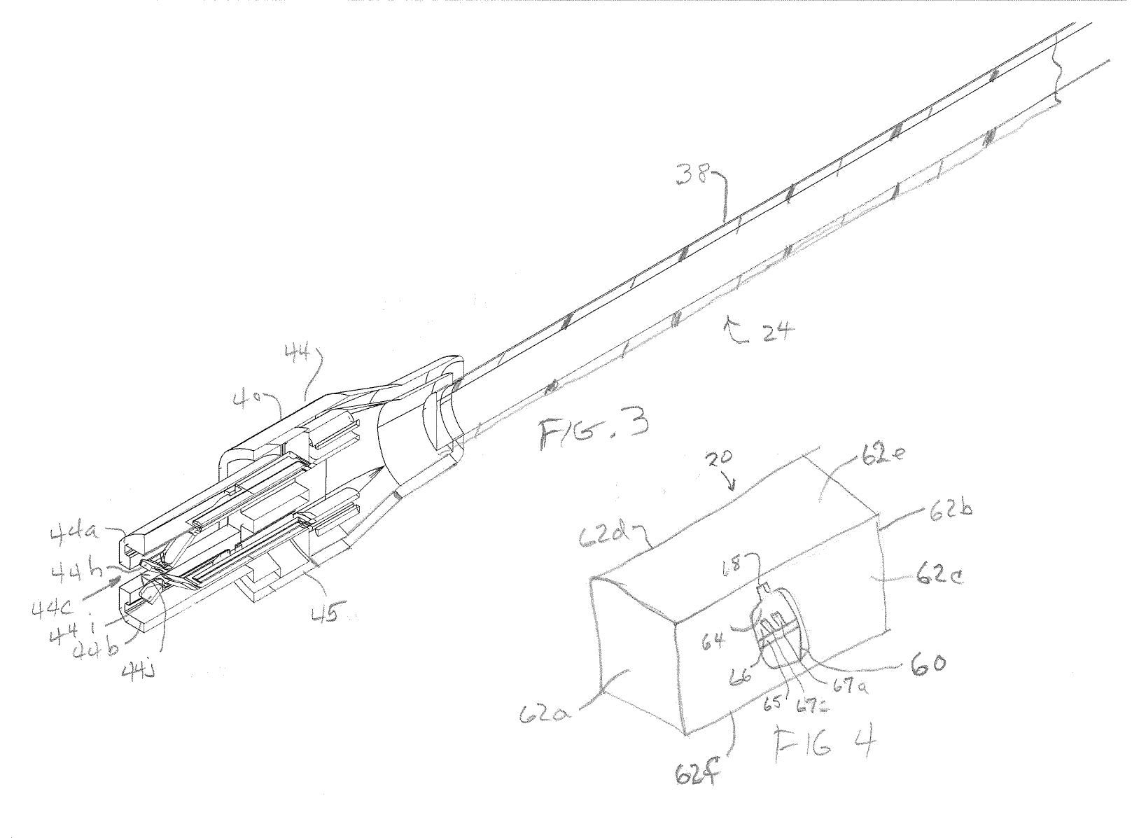

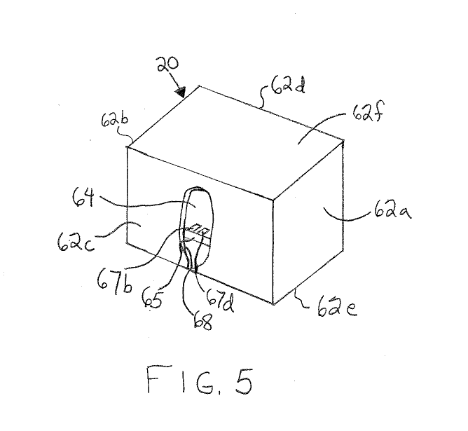

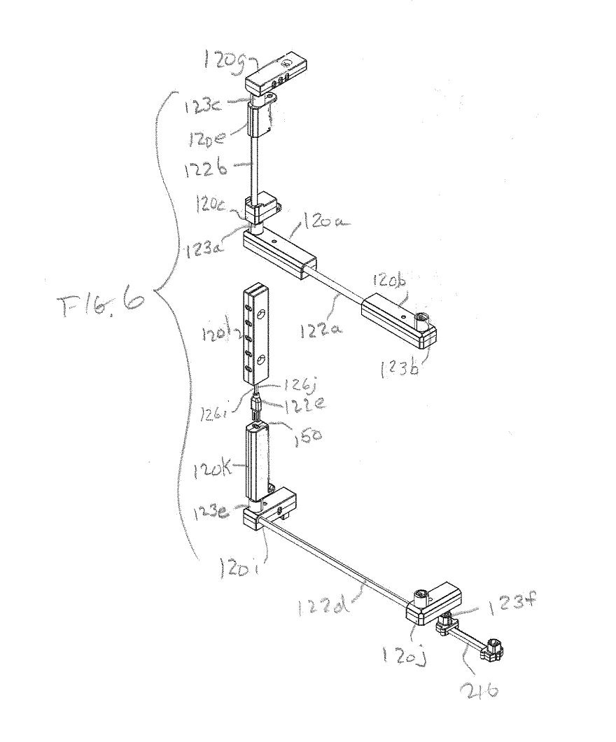

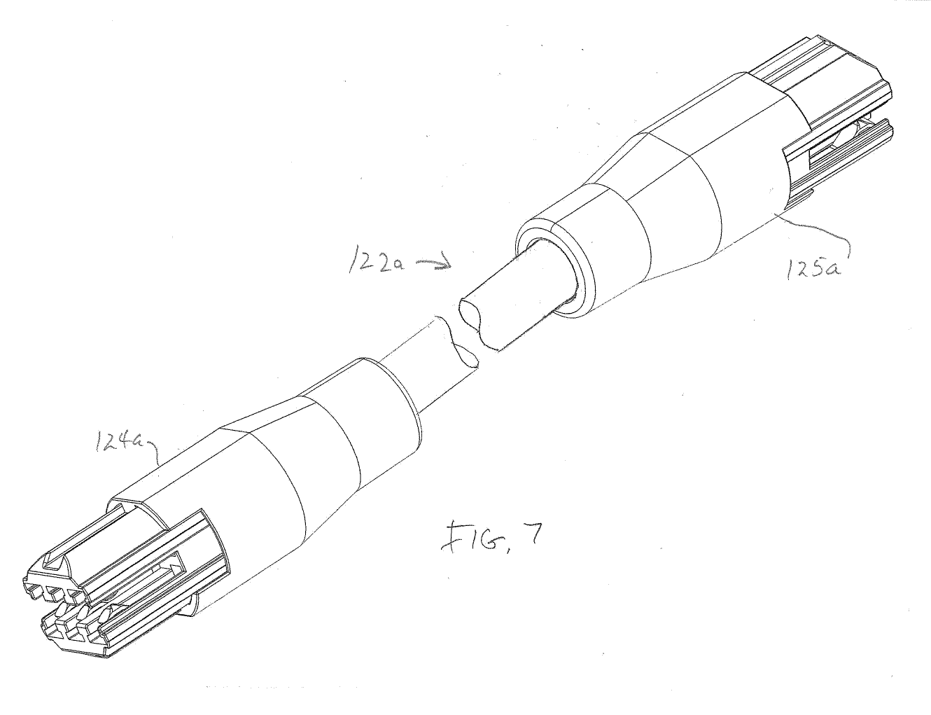

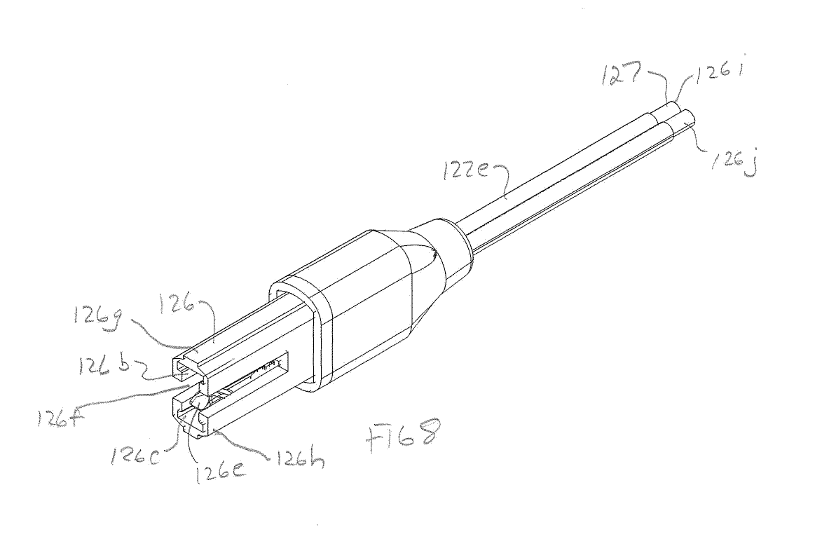

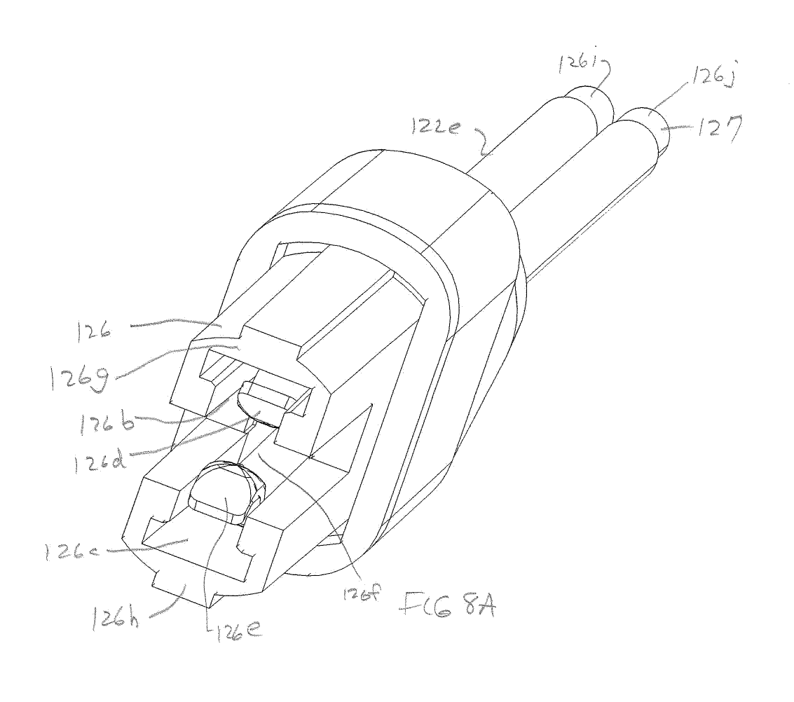

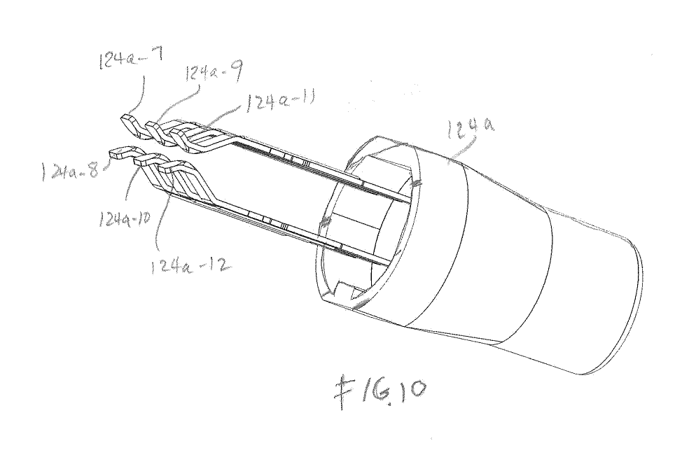

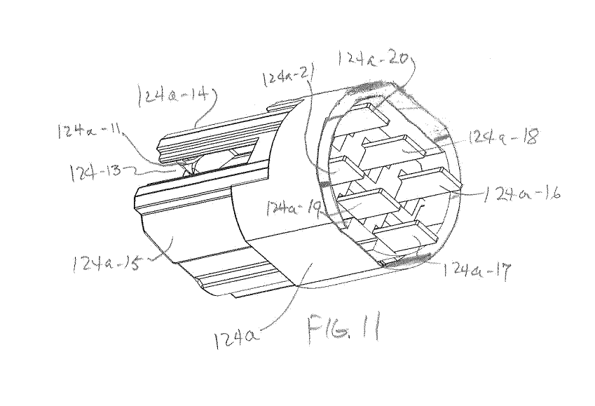

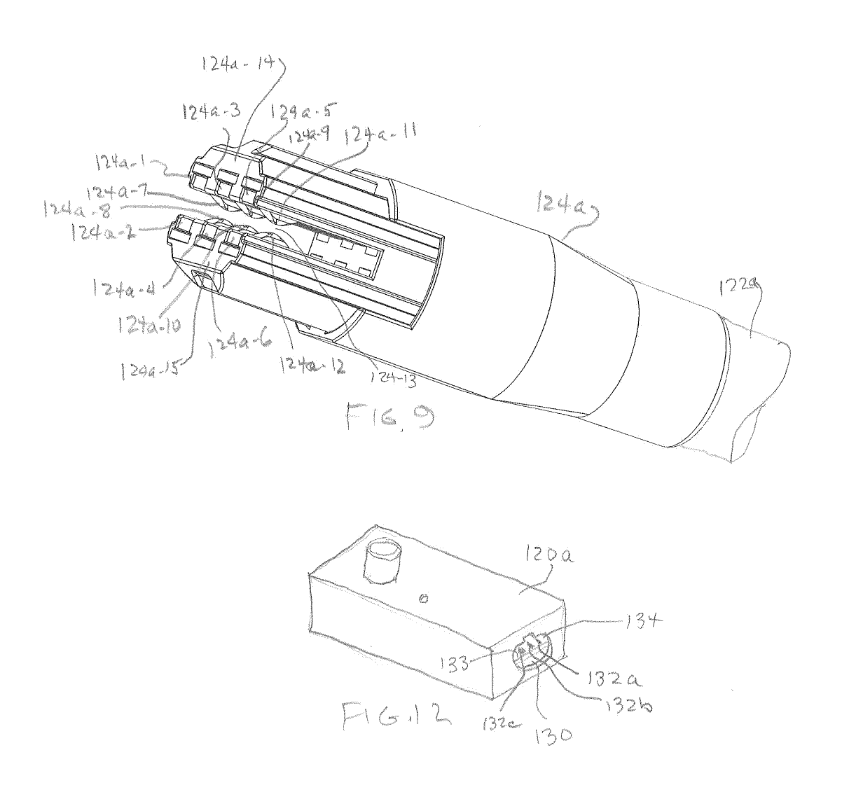

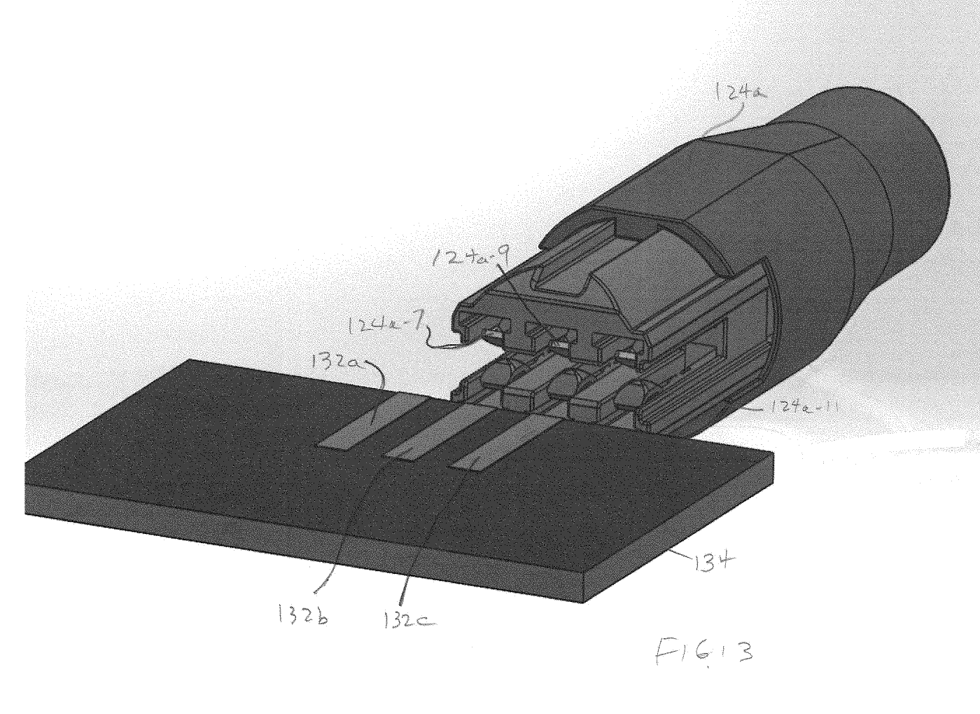

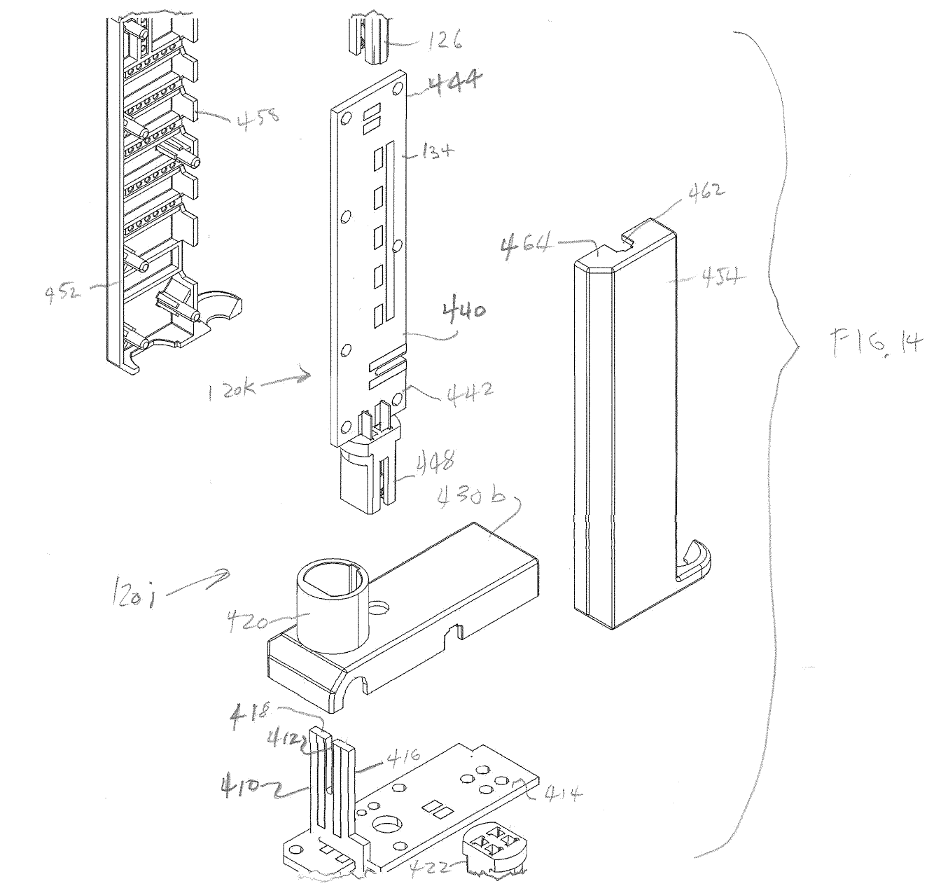

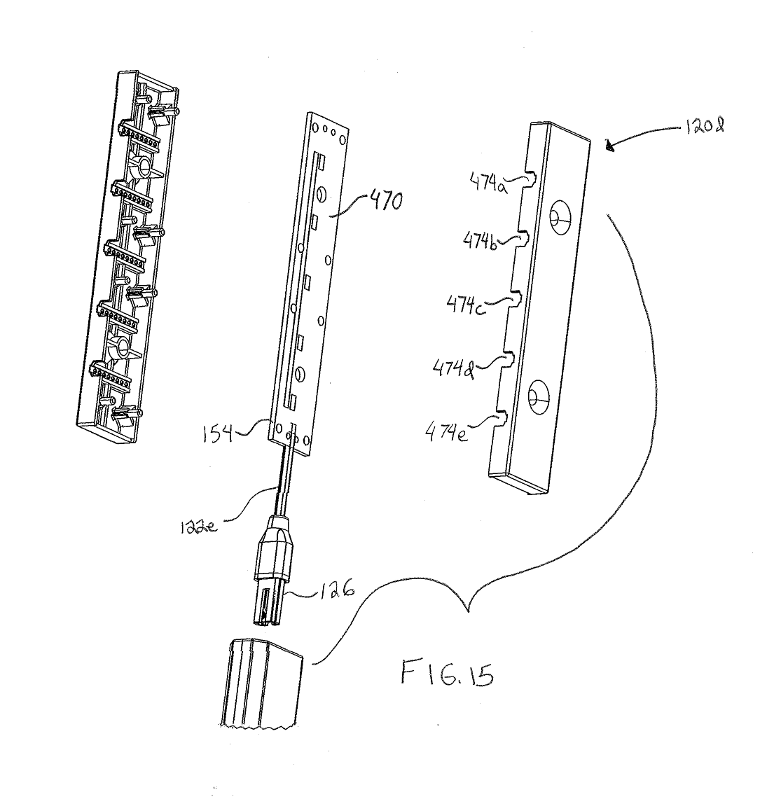

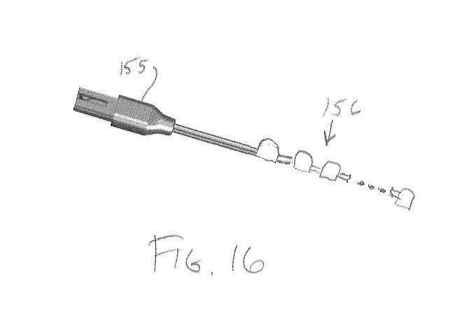

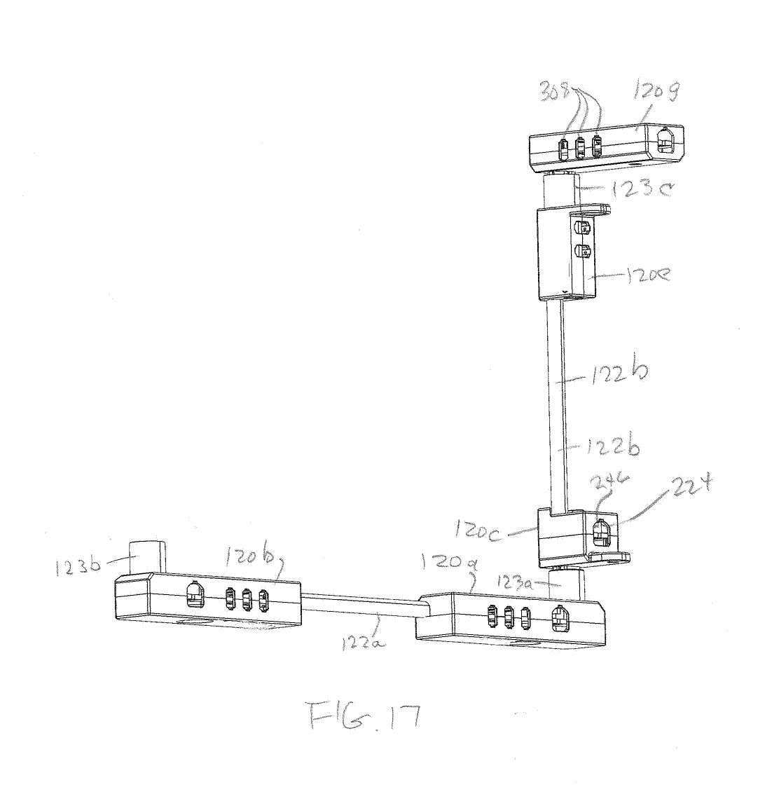

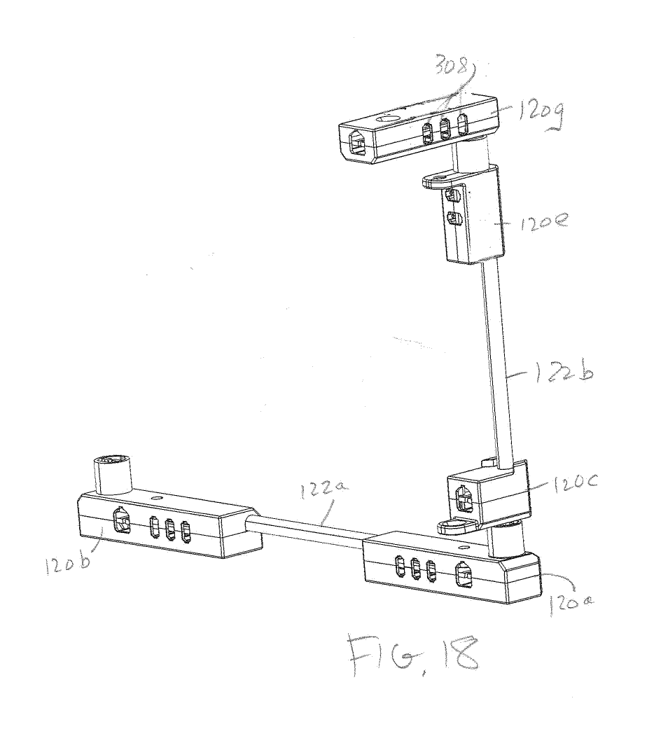

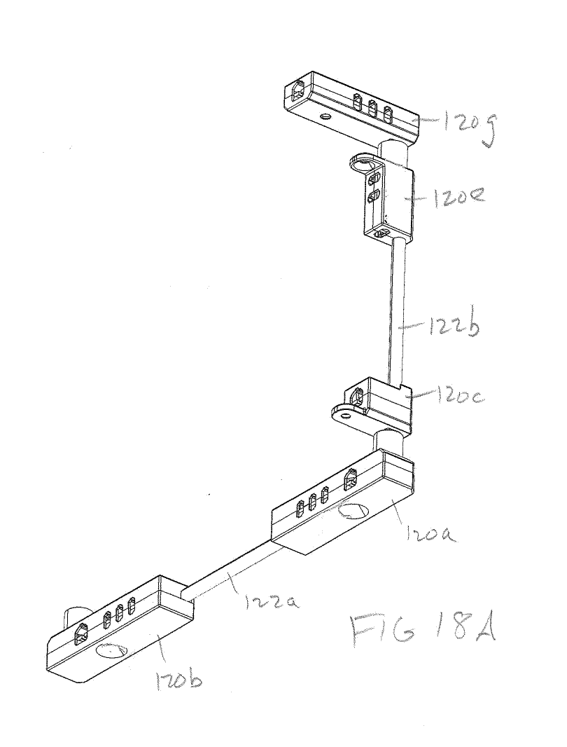

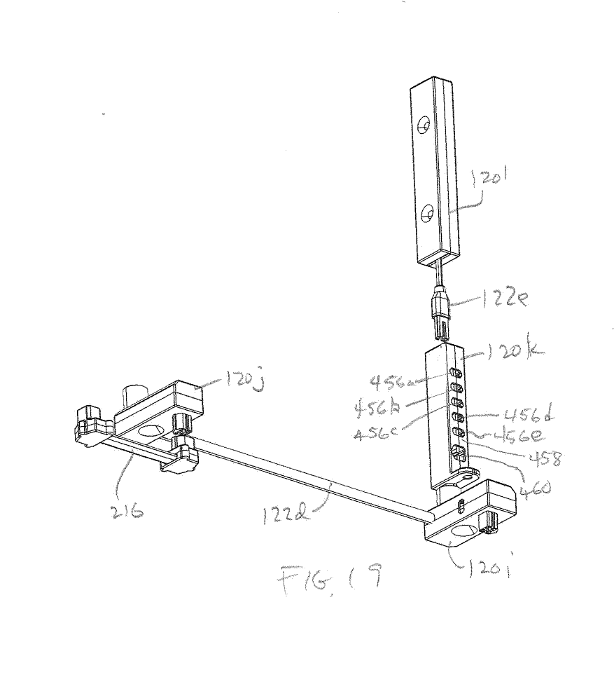

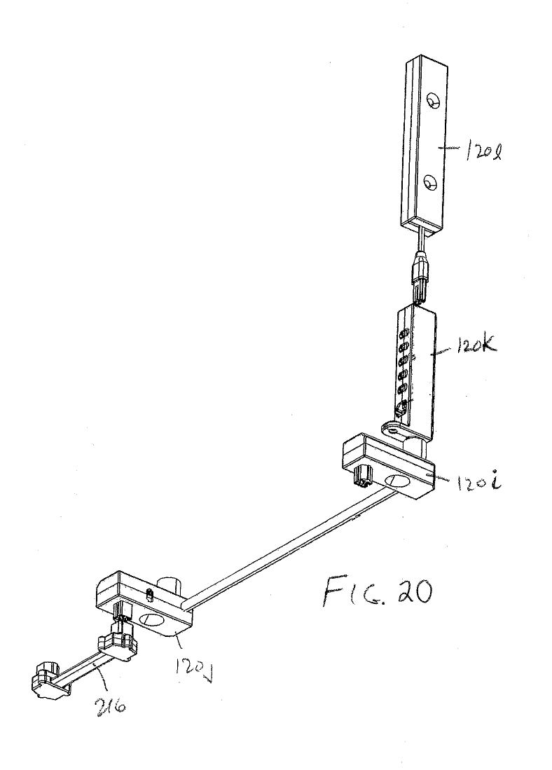

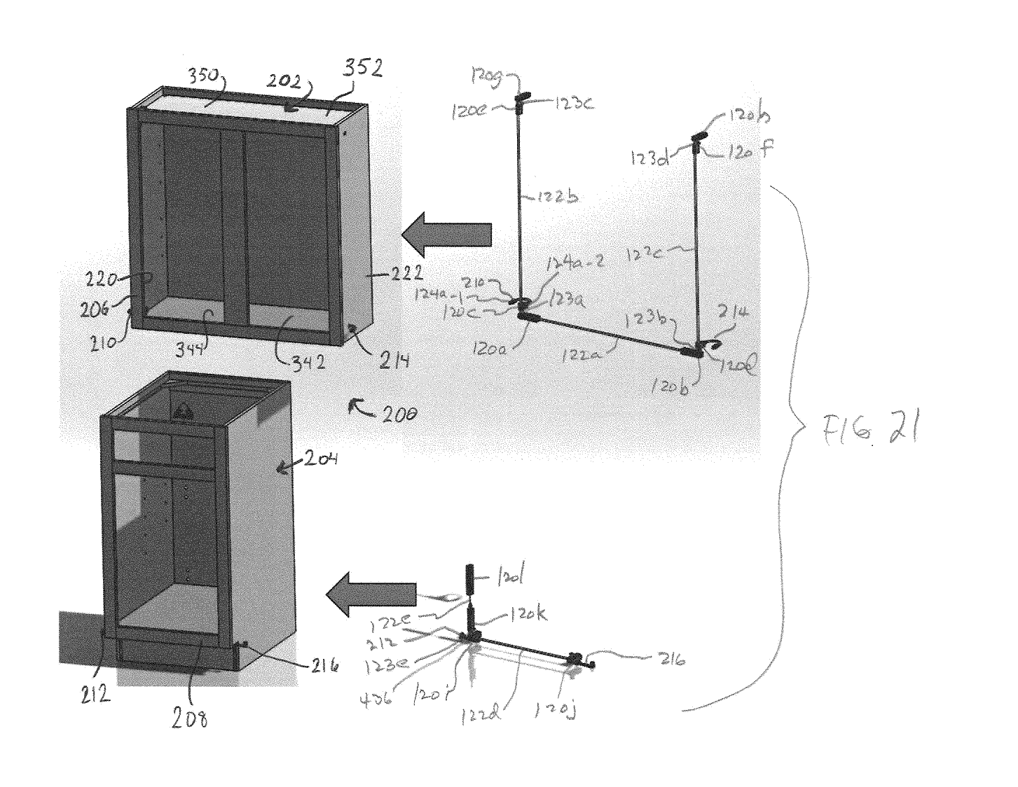

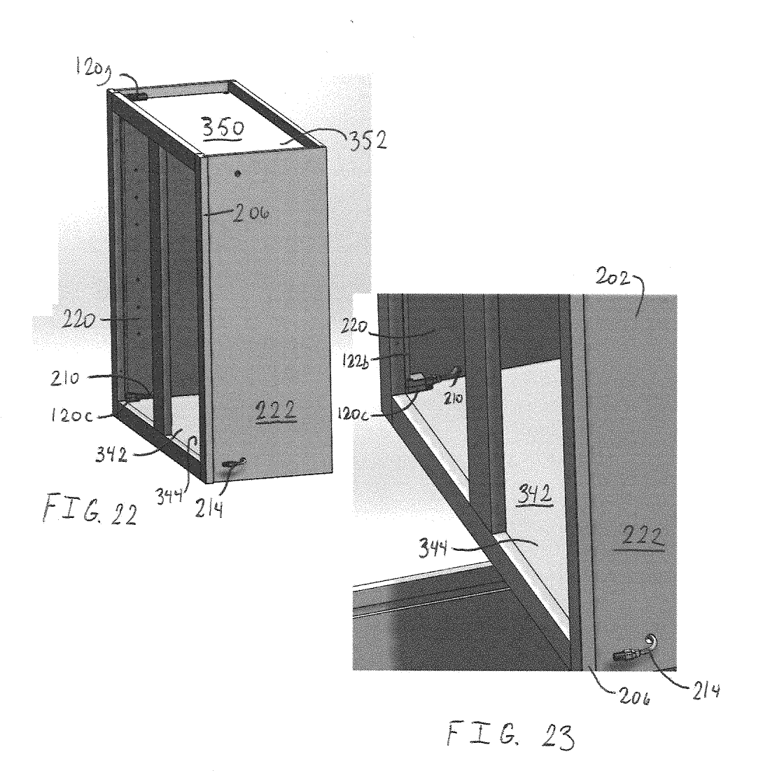

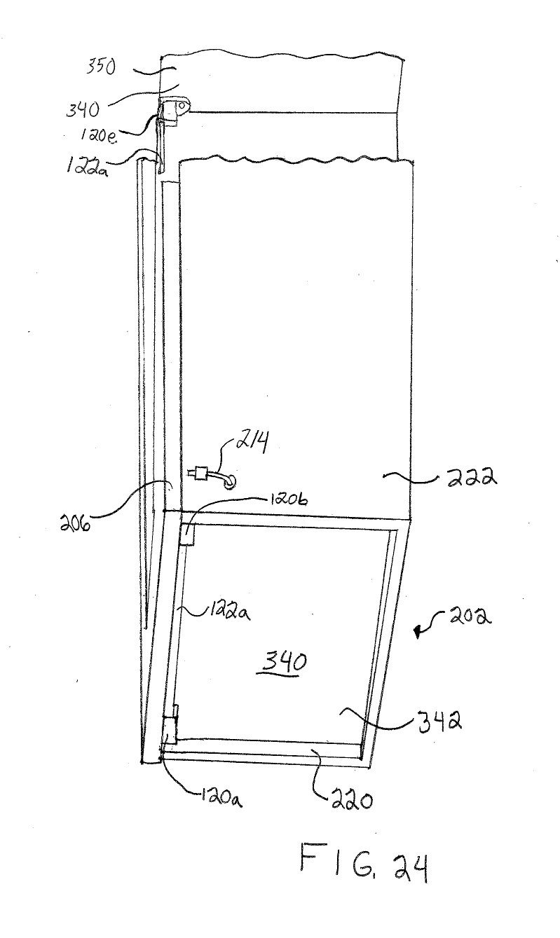

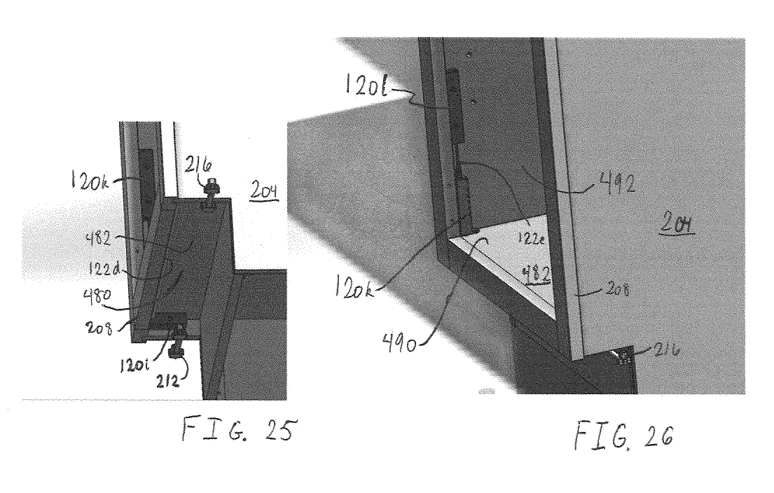

Referring next to FIGS. 2 and 3, according to an exemplary embodiment, the cable 24 includes a flexible or rigid sheath 38 and is terminated at first and second ends 40, 42 by first and second connector plugs 44, 46, respectively. The connector plugs 44, 46 may be identical to one another, substantially similar, or different than one another. In the illustrated exemplary embodiment the connector plugs 44, 46 are identical to one another, and hence only the connector plug 44 will be described in detail. The plug 44 comprises a collar portion 45 and first and second spaced plug portions 44a, 44b extending axially away from the collar portion 45. The plug portions 44a, 44b together define a split plug end 44c having a reduced cross sectional size relative to the collar portion 45. In the illustrated exemplary embodiment each plug portion 44a, 44b includes at least one, and more preferably two (or more, such as three as described below) pairs of contact recesses 44d, 44e and 44f, 44g, respectively. Inwardly extending flexible and/or spring-loaded contacts 44h, 44i, are disposed in the contact recesses 44d, 44e, respectively, wherein the contacts 44h, 44i may be (but need not be) aligned with one another and extend into a recess 44j between the plug portions 44a, 44b. Contacts 44k, 44l identical to the contacts 44h, 44i may be disposed in the contact recesses 44f, 44g, respectively, and extend into the recess 44j. The contacts 44k, 44l may be (but need not be) aligned with one another. Each contact 44h, 44i, 44k, and 44l (only visible in FIG. 2) is electrically coupled to an associated conductor (not shown) in the cable 24 by suitable means, such as soldering, crimping, and/or clamping or otherwise.

As seen in FIGS. 4 and 5, the connector plug 44 is adapted to be inserted into and retained within any of a number of receptacle(s) or socket(s) 60 disposed in a sidewall 62a, 62b, front wall 62c, rear wall 62d, top wall 62e, and/or bottom wall 62f of the module 20. In the illustrated exemplary embodiment, the connector plug 44 is received and retained within a receptacle or socket 60 comprising a medium size port disposed in the front wall 62c or in the rear wall 62d. The receptacle or socket 60 includes an opening 64 and an edge 65 of a circuit board or other substrate 66 is disposed adjacent the opening 64. Conductive traces 67a, 67b, 67c, 67d are disposed on opposing sides of the substrate 66 also adjacent the opening 64 in alignment with associated contacts 44h, 44i, 44k, 44l, respectively, when the plug portions 44a, 44b are inserted into the opening 64. It may be noted that the opening 64 is of a size and shape to receive the plug portions 44a, 44b snugly and the opening 64 may include a keying feature in the form of a slot 68 that receives a mating feature in the form of a projection 69 (FIG. 2) when the plug portions 44a, 44b are received in a proper orientation in the opening 64.

As noted in greater detail hereinafter, the module 20 includes additional receptacles or sockets like the receptacle or socket 60 and traces on or in the substrate 66 interconnect the traces 67a-67d with other traces located at or adjacent the additional receptacles or sockets.

The electrical connection between the conductors in the cable 24 and the traces on the substrate 66 via the contacts 44h, 44i, 44k, and 44l is accomplished easily by an installer by simply inserting the connector plug 44 into the receptacle or socket 60. The flexible and/or spring-loaded contacts 44h, 44i, 44k, and 44l travel over the edge of the substrate 66 and grip opposite faces of the edge of the substrate 66 proximate the receptacle or socket 60. The contacts 44h, 44i, 44k, and 44l are urged into electrical contact with the associated traces 67a-67d, respectively, to establish electrical connections with the traces and retain the connector plug 44 firmly in the receptacle or socket 60. This electrical and mechanical connection is facilitated by the resiliency and/or spring loading of the contacts 44h, 44i, 44k, and 44l, which ensure that such contacts bear against the traces 67a-67d, respectively, with a desired force. In like manner, the connector plug 46 (which, as noted above, may be identical or similar to the plug 44) may be inserted into a receptacle or socket similar or identical to the element 60 comprising a port of the module 22. In the illustrated exemplary embodiment module 22 includes a substrate having traces and a substrate edge disposed proximate an opening similar or identical to the positioning and configuration of the substrate 66 in the module 20. Such insertion of the connector plug 46 establishes connections between four (or more) contacts in the plug 46 and the associated traces on the substrate of the module 22 to interconnect the modules 20 and 22 electrically.

Referring also to FIG. 1, as noted above, suitable electric power may be delivered to either module 20, 22 by a cable 76 similar or identical to the cable 24 and may be transferred to the other module 22, 20 by the cable 24. For example, the module 20 may include a further receptacle or socket (not shown) comprising a port in the wall 62d. Such receptacle or socket may be similar or identical to the receptacle or socket 60 wherein an edge of the substrate 66 and two pairs of traces like the traces 67a-67d are disposed on the substrate 66 adjacent to the further receptacle or socket (one pair of traces being on one side of the substrate 66 and the other pair being on the opposite side of the substrate 66). The cable 76 includes a connector plug 78 similar or identical to the connector plugs 44, 46 and the plug 78 is inserted into the further receptacle or socket. Suitable power is delivered from a power source to the cable 76 and thence to the traces disposed adjacent the further receptacle or socket, which are electrically interconnected to the traces 48a-48d by one or more conductors on and/or in the substrate 66. Thus, for example, electric power is transferred to the cable 24 and the electric power may be delivered to the conductive traces on the substrate of the module 22 via the plug 46. The electric power may be delivered to the strings of LEDs 28a, 28b via conductive traces on the substrates of the modules 20, 22 and cables 82, 84 similar or identical to the cable 24 that are inserted into and retained within still further receptacles or sockets (also not shown) comprising ports of the modules 20, 22. The still further receptacles or sockets may be similar or identical to the receptacle or socket 60 (except for size) and the cables 82, 84 include contacts identical or similar to the contacts 44h, 44i, 44k, and 44l described hereinabove that interconnect with traces disposed on edges of the substrate 66 and the substrate of the module 22 located proximate the still further receptacles or sockets.

The cable 24 (and the cable 76) may supply power to control two or three loads (or groups of ganged loads) separately and independently. In one arrangement, two hot and two ground connections are provided to supply power to two independent groups of loads. In another arrangement, three hot connections and a single ground connection are provided for three independent loads.

If desired, the one or more of the traces and substrate may be replaced as desired by other device(s), such as discrete wiring, switching devices, for example, arranged in one or more switch matrices, and/or a combination of the foregoing interconnection devices, or the like, provided that such elements interconnect one or more sources of power to one or more other modules and/or loads.

FIGS. 6 and 21 illustrate an alternative exemplary embodiment in which a plurality of separate modules 120a, 120b, 120c, . . . , 120l is provided, it being understood that the number and type(s) of modules may vary from those shown. It should be noted that the modules 120d, 120f, and 120h are illustrated only in FIG. 21 for simplicity. In the illustrated exemplary embodiment of FIGS. 6 and 21, each module 120 is interconnected with at least one other module 120. Each of the modules 120 preferably includes a housing with at least one receptacle or socket comprising a port having a port opening, and at least one substrate, preferably, although not necessarily, comprising a circuit board contained in the housing. The substrate carries at least one conductor therein and/or thereon and at least an edge of the substrate at which the at least one conductor is disposed is accessible through the port opening so that a connector plug may extend into the opening and at least partially surround the edge of the substrate such that the at least one conductor is electrically coupled to at least one contact carried by the connector plug, similar or identical to the embodiments described hereinabove. The at least one conductor (or another conductor or set of conductors) electrically interconnects the port to one or more other ports of the module to transfer electrical power therebetween and, optionally, between devices connected to such ports. In the preferred embodiment, each port that is to supply power to a load is coupled electrically to at least one, and more preferably, all ports and male or female connectors (described in detail below) that receive or transmit power between modules 120. If desired, the substrate may include conductor(s) in the form or electrically conductive printed circuit board traces such as those disclosed in U.S. Provisional patent application Ser. No. 62/506,611 filed May 16, 2017, entitled “Electric Power Distribution Module and System” owned by the assignee of the present application and the disclosure of which is hereby incorporated by reference herein.

In the illustrated exemplary embodiment, the interconnections between modules 120 may in some cases be effected by conductors in a flexible or rigid cable 122a-122e and/or by interfitting e.g., mating, plug and receptacle or socket combinations 123a-123f (one comprising a male connector and the other comprising a female connector) wherein each portion (i.e., male or female connector) of each combination 123 is integral with an associated module as described hereinafter. (The combination 123d and the cable 123c are only visible in FIG. 21) The cables 122a-122d include a plurality of conductors therein, for example, six conductors, and each end may comprise stripped ends of the conductors, which case the stripped ends are hard wired (e.g., soldered, crimped, and/or clamped) to substrates in the respective modules. Alternatively, one or both ends of the cables 122a-122d may comprise a connector plug similar or identical to the connector plug 44 described above, except as to the number of conductors in the cable and the number of associated contacts in the connector plug, as described below.

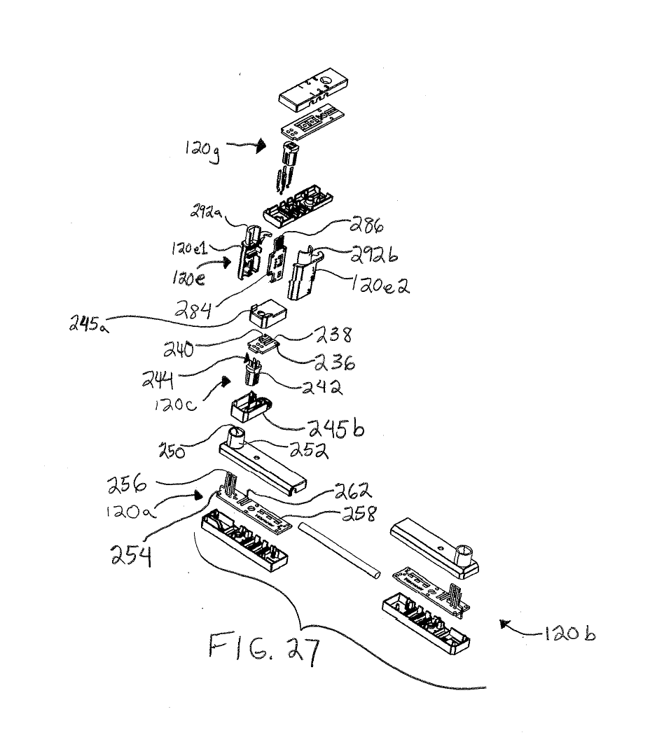

Specifically, in the illustrated exemplary embodiment of FIG. 7, each cable 122a-122d, such as the cable 122a, includes two identical or similar large size connector plugs 124a and 125a at opposite ends thereof described in greater detail below. As seen in FIG. 8, the cable 122e, on the other hand, includes a single small size connector plug 126 as described below terminating one end thereof with a different connector or bare wires at the other end 127 thereof. In the illustrated exemplary embodiment, each of the cables 122a-122e is identical to the cable 24, with the exception that each of the cables 122a-122d includes six conductors (not shown) while the cable 122e includes two conductors. Further, each connector plug 124, 125, and 126 includes a number of contacts each like the contacts 44h and equal in number to the number of conductors in the associated cable and connected thereto as in the previous embodiment. (It should be noted that some of FIGS. 6-30 illustrate four contacts for the connector plugs 124, 125 and a corresponding number of traces on each substrate or auxiliary substrate of each module 120 proximate corresponding or associated ports, even though the contacts of each connector plug 124, 125 and each associated set of traces aligned with such contacts are, in fact, six in number in such embodiment(s).)

Thus, for example, the connector plug 124a of the cable 122a shown in FIGS. 9-11 is identical to the connector plugs 124b-124d and 125a-125d and includes three pairs of contact recesses 124a-1 through 124a-6 in which six contacts 124a-7 through 124a-12 are disposed, respectively. Each contact 124a-7 through 124a-12 is identical or similar to the contact 44h of the embodiment described hereinabove and the contacts 124a-7 through 124a-12 are resilient and/or spring loaded and extend into a recess 124a-13 (FIGS. 9 and 11) between plug portions 124a-14 and 124a-15 . As in all other embodiments disclosed herein each of the six conductors in the cable 122a is electrically coupled by any suitable means (e.g., soldering and/or crimping and/or clamping) to an associated end 124a-16 through 124a-21 (FIG. 11) of one of the contacts 124a-7 through 124a-12, respectively. Like the connector plugs 44, 46 the connector plug 124a may be inserted into and retained within a mating receptacle or socket 130 (FIG. 12) comprising a large size port of the module 120a such that the contacts 124a-7, 124a-9, and 124a-11 are urged into and maintained in electrical contact with conductive traces 132a-132c disposed on a top side 133 of a substrate 134 located within the module 120a (FIG. 13) and the contacts 124a-8, 124a-10, 124a-12 are urged into and maintained in electrical contact with conductive traces (not shown) disposed on a lower side 135 of the substrate 134 similar or identical to the embodiment of FIGS. 2-5 described above. Each of the traces 132a-132c is aligned with an associated one of the traces on the lower side 135 although this is not strictly necessary, in which case the spacing of the contacts 124-8, 124-10, and 124a-12 are modified accordingly. In like manner, the connector plug 125a (FIG. 7) is inserted into and retained within a mating receptacle or socket (not shown) of the module 120b identical to the receptacle or socket 130 such that contacts of the connector plug 125a are urged into electrical contact with conductive traces of a substrate of the module 120b. Electric power may thus be transferred between the modules 120a, 120b and, by virtue of the conductive traces of the modules, to one or more devices connected thereto, such as other modules or loads.

In another exemplary embodiment, the small size connector plug 126 of the cable 122e shown in FIGS. 8 and 8A includes one pair of contact recesses 126b, 126c in which two contacts 126d, 126e are disposed, respectively. Each contact 126d, 126e is identical or similar to the contact 44h of the embodiment described hereinabove and the contacts 126d, 126e extend into a recess 126f between plug portions 126g, 126h and the contacts 126d, 126e are resilient and/or spring-loaded. Each of two conductors 126i, 126j (FIGS. 6, 8, 8A) in the cable 122e is coupled to an associated one of the contacts 126d, 126e as described above. Like the connector plugs 44, 46 the connector plug 126 may be inserted into and retained within a receptacle or socket 150 (FIG. 6) comprising a small size port of the module 120k such that the contacts 126d, 126e are maintained in electrical contact with a conductive trace 152a, and a further conductive trace (not shown) on an opposite side of the substrate 134, both being disposed proximate an edge of the substrate 134 (See FIG. 14). In the illustrated exemplary embodiment shown in FIG. 15 an opposite end of the cable 122b comprises bare wires that are soldered crimped, clamped, or otherwise securely connected to traces of a substrate 154 disposed within the module 120l. One or more other cables 155 (seen in FIG. 16) identical or similar to the cable 122e may be used to connect one or more loads 156, such as LED strings (one of which is shown in FIG. 16), to modules 120 in a connection arrangement as determined by an installer. In such a case, the load(s) may be hard wired to the bare wires of such cable(s) (as shown), or each cable may have a connector plug identical to, similar to, or different than the connector plug 126 that mates with a further mating connector such as is disclosed herein and connected to the load(s).

The cable 122b or 156 is capable of supplying power for controlling a single load or multiple ganged loads together whereas the cable 122a is capable of suppling power for controlling up to three loads (or up to three groups of ganged loads) independently using three separate hot and three separate ground connections, as desired. Each of the modules 120a-120l includes one or more receptacles or sockets that may be capable of receiving the connector plugs of one or more of the cable(s) 24, 76, 122a, 122b, and /or any other cable(s) as necessary or desirable. Thus, for example as seen in FIGS. 6, 17, and 18, the module 120g has one large size port capable of receiving the connector plug of the cable 122a, six small size ports capable of receiving the connector plug of the cable 122e, and a single other male connector in the form of a plug that connects the module 120g to the module 120e. The remaining modules have ports/other connectors as follows:

| | Small | Large | Other |
|---|---|---|---|
| Module | Ports | Ports | Connectors |
| 120a | 3 | 1* | 1 (female) |
| 120b | 3 | 1* | 1 (female) |
| 120c | 0 | 1* | 1 (male) |
| 120d | 0 | 1* | 1 (male) |
| 120e | 3 | 0 | 1 (female) |
| 120f | 3 | 0 | 1 (female) |
| 120g | 6 | 1 | 1 (male) |
| 120h | 6 | 1 | 1 (male) |
| 120i | 1 | 0* | 2 (1 female, 1 male) |
| 120j | 1 | 0* | 2 (1 female, 1 male) |
| 120k | 6 | 1 | 1 (male) |
| 120l | 6 | 1 | 1 (male) |

*Add one large port for each connection to the respective module by another module using a connector plug.

FIGS. 21-26 illustrate an exemplary set of kitchen cabinets 200 comprising an upper cabinet 202 and a lower or base cabinet 204, it being understood that a typical kitchen cabinet installation may include additional base cabinet(s) and/or upper cabinets. The modules 120a-120h may be mounted behind a face frame 206 of the upper cabinet 202 while the modules 120i-120l may be mounted behind a face frame 208 of the base cabinet 204, although one or more of the modules may be mounted at different location(s) on or in the cabinets. Power to the modules 120a-120l may be provided via upper and lower jumpers 210, 212 and power to module(s) in other cabinet(s) may be provided via upper and lower jumpers 214, 216. It should be noted that power may instead flow in the opposite direction so that power may be provided via the jumpers 214, 216 to the modules 120a-120l and may be provided to module(s) in other cabinet(s) via the jumpers 210, 212.

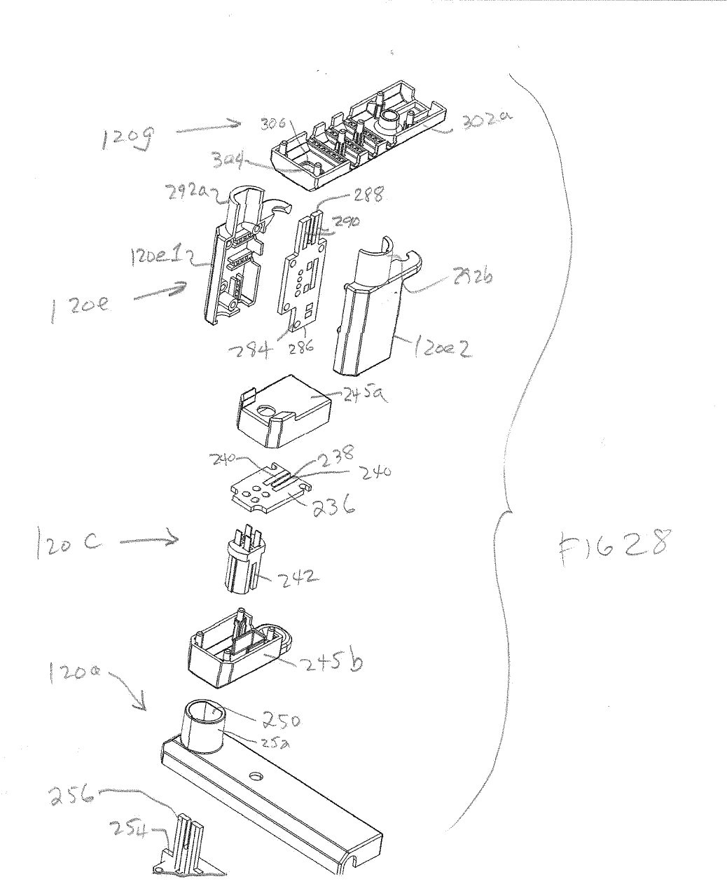

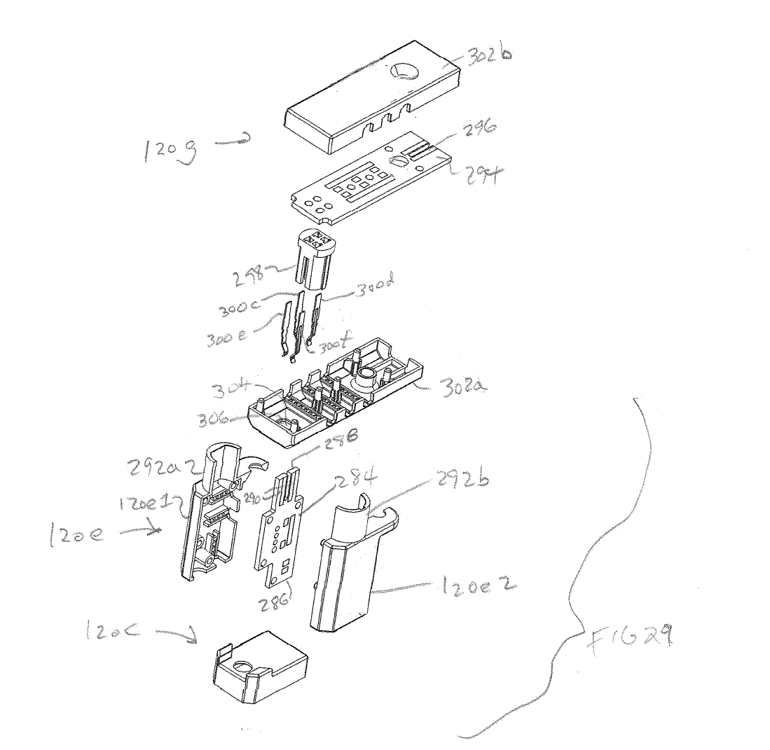

In any event, the jumpers 210 and 214 extend through side walls 220, 222 of the upper cabinet 202 and are coupled to receptacles or sockets 224, 226 (FIG. 17), respectively, of the modules 120c and 120d. The jumper 210, receptacle or socket 224, and modules 120a, 120c, 120e, and 120g are identical to the jumper 214, receptacle or socket 226, and modules 120b, 120d, 120f, and 120h, respectively, (except as being mirror images of one another), and hence, only the jumper 210, connector 224, and modules 120a, 120c, 120e, and 120g will be described in detail herein. Referring first to FIG. 21, the jumper 210 includes a plurality of electrical conductors therein, a first end that may be terminated by a connector plug 124a-1 identical to the connector plug 124a and a second end terminated by a further, identical connector plug 124a-2. As seen in FIGS. 27 and 28, the module 120c includes a substrate 236 preferably in the form of a circuit board having an edge 238 wherein electrical traces 240 are disposed on the substrate 236 including at the edge 238. A connector plug 242 is secured to and carried on the substrate 240. The connector plug 242 may be similar or identical to the connector plug 124a and includes contacts 244 that are electrically connected to traces on the substrate 236 by solder, crimping, clamping, or otherwise. The module 120c includes housing portions 245a, 245b together comprising a first bore 246 (FIG. 17) adjacent the edge 238 of the substrate 240 and defining the receptacle or socket 224 and a second bore (not visible) that supports the connector plug 242. Referring to FIGS. 21, 27, and 28 each contact of the second end 124a-2 is electrically connected with an associated trace 240 disposed on the edge 238 of the substrate 236 when the second end 124a-2 is mated with the receptacle or socket 224. Each trace 240 is electrically connected to an associated contact 244 of the connector plug 242, and hence, each contact 244 in the connector plug 242 is electrically connected to an associated contact in the second end 124a-2.

Referring to FIGS. 27 and 28, the connector plug 242 is shaped to fit into and mate with a female connector 250 of the module 120a. The connector 250 includes a cylindrical wall 252 that surrounds an end of a substrate 254 in the form of an auxiliary circuit board that includes traces 256. The substrate 254 is secured electrically and mechanically in any suitable fashion to a substrate 258 (FIG. 27) comprising a main circuit board of the module 120a having traces 262 disposed thereon and/or therein. Each trace 256 is electrically coupled to an associated trace 262 such that, when the connector plug 242 is fully inserted into the connector 250, the contacts 244 are urged into electrical contact with the traces 256 just as in the embodiments described previously, and the interconnections between the traces 256 and 262 cause the contacts 244 to be electrically connected to the traces 262 of the module 120a.

As seen in FIGS. 6, 17, and 21, the traces 240 are connected by the cable 122b to traces 282 carried by and/or in a substrate 284 comprising a circuit board of the module 120e. (It may be noted that the cable 122b is omitted in FIGS. 27-29). The cable 280 may comprise six conductors with one or both ends comprising stripped ends, in which case each stripped end of each conductor is soldered or otherwise coupled to an associated trace 240 or 282. Alternatively, the cable 280 may have a connector plug at one or both ends thereof similar or identical to the cable 122a having connector plugs 124a wherein the connector plug(s) may be matingly received in large size ports (not shown) of the module 120c and/or 120e similar or identical to the port 155 described hereinabove. In the case of the module 120e, the large size port is disposed adjacent a first edge 286 of the substrate 284 as in the embodiments described hereinabove. Referring also to FIGS. 27-29, second edge 288 of the substrate 284 opposite the first edge 286 includes traces 290 and extends into a cylindrical female connector 292 comprised by female connector portions 292a, 292b of module housing portions 120e1, 120e2 similar or identical to the connector 250.

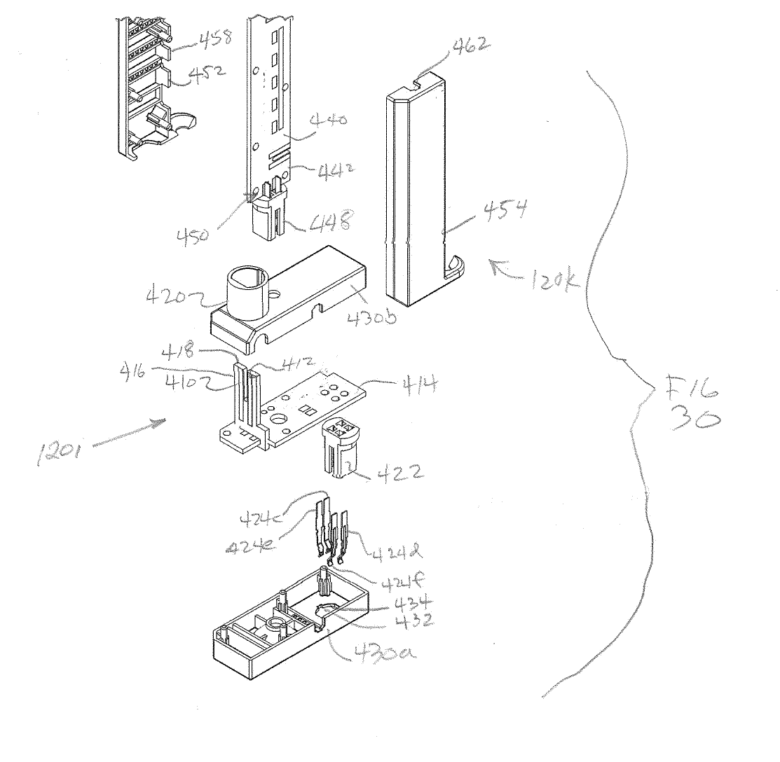

Referring specifically to FIG. 29, the module 120g includes a substrate 294 in the form of a printed circuit board having traces 296 disposed therein and/or thereon. A connector plug 298 is secured to and carried on the substrate 294. In the illustrated exemplary embodiment the connector plug 298 is identical to the connector plug 124a and includes contacts 300a-300f that are electrically connected to the traces 296 on the substrate 294 by solder, crimping, clamping, or otherwise. The module 120g includes housing portions 302a, 302b. The housing portion 302a comprises a bore 304 defined by a surface 306 that supports the connector plug 298. The connector plug 298 is sized to fit matingly into the connector 292 to establish a path for power transfer between the modules 120e and 120g. The housing portions 302a, 302b together define small size receptacles or sockets 308 (FIGS. 13 and 18) disposed adjacent the traces 296 of the substrate 294 to provide power to one or more loads connected thereto, for example using a cable like the cable 122b.

As seen in FIGS. 21-23, the interconnected modules 120a and 120b are secured to a lower surface 340 of a lower panel 342 of the cabinet 202 with the socket or receptacle 250 and the corresponding socket or receptacle of the module 120b extending upwardly through holes or bores (not visible) in the lower panel 342. The modules 120c and 120d are disposed on and secured to an upper surface 344 of the lower panel 342 in the cabinet 202. The modules 120e and 120f are secured to a lower surface 348 of an upper panel 350 and the modules 120g and 120h are disposed on and secured to an upper surface 352 of the upper panel 350 such that the connector 292 of the module 120e and the corresponding connector of the module 120f extend upwardly through bores (not visible) in the upper panel 350. The modules 120a-120h may be secured to the respective surfaces by screws or other fasteners.

Referring to FIGS. 6, 19, and 20, the modules 120i, 120j are interconnected by the cable 122d having one or both stripped ends hand wired to one or both of the modules 120i, 120j or one or more ends terminated by connector plugs identical to the connector plug 124a and that are inserted into receptacles or sockets, as described in connection with the modules 120a and 120b. The modules 120i and 120j are outwardly identical to the modules 120a and 120b except that the modules 120i and 120j are oriented ninety degrees with respect to the modules 120a and 120b and each of the modules 120i and 120j additionally includes connector plugs located on lower faces as described below. These connector plugs are coupled to receptacles of the jumpers 212 and 216, respectively.

In the illustrated exemplary embodiment, the modules 120i, 120j are identical to one another, except that the module 120j is a mirror image of the module 120i, and hence, only the module 120i will be described in detail hereinafter. As seen in FIGS. 14 and 30, the module 120i includes an auxiliary substrate 410 in the form of a circuit board with traces 412 therein and/or thereon and which is similar or identical to the substrate 254. The substrate 410 is electrically and mechanically coupled to a top side of a main substrate 414 such that the traces 412 are electrically interconnected by solder, crimping, clamping, or otherwise with traces 415 in and/or on the main substrate 414. An upper end 416 of the substrate 410 includes traces 412 at or adjacent an edge 418 that is surrounded by a cylindrical wall 420, which, in the illustrated exemplary embodiment, is identical to the cylindrical wall 252 of the module 120a. A connector plug 422, which, in the illustrated exemplary embodiment, is identical to the connector plug 242, is secured to and carried on a lower surface of the main substrate 414. The connector plug 422 includes contacts 424a-424f similar or identical to the contacts 242a-242f that are electrically connected to the traces 415 on the main substrate 414 by solder, crimping, clamping, or otherwise.

The module 120i further includes housing portions 430a, 430b. The housing portion 430a comprises a bore 432 defined by a surface 434 (both seen in FIG. 30) that supports the connector plug 422. The connector plug 422 is sized to fit matingly into a connector such as the connector 436 of the jumper 212 (FIG. 21) to establish a path for power transfer between the module 120i and another module and/or device as described previously

The module 120k includes a substrate 440 in the form of a printed circuit board having a first or lower end 442, a second or upper end 444. and traces 446. The traces 446 interconnect a connector plug 448 electrically and mechanically secured to the substrate 440 and disposed at the lower end 442 with other ports/connectors thereof, such as the portions of the traces 446 located at or adjacent the upper end 444. In the illustrated exemplary embodiment, the connector plug 448 is similar or identical to the connector plug 422 and includes contacts 450 similar or identical to the contacts 242a-242f that are soldered, crimped, clamped, or otherwise connected to the traces 446. Module portions 452, 454 of the module 120k include surfaces defining receptacles or sockets 456a-456e (FIG. 19) comprising small size ports in a side 458. A further receptacle or socket 460 comprising a large size port is further defined in the side 458 while a receptacle or socket 462 (FIG. 14) comprising a small size port is defined in a top end surface 464 that receives the connector plug 126 of the cable 122e, as described previously.

Referring next to FIG. 15, as also described above, the module 120l includes a substrate 470 that includes traces 472 to which are electrically connected stripped ends of the conductors of the cable 122e. The traces 472 electrically interconnect the stripped ends of the cable 122e with receptacles or sockets 474a-474e comprising small size ports.

Referring to FIGS. 21, 25, and 26 the modules 120i and 120j are mounted in any suitable fashion, such as by screws or other fasteners, to a lower surface 480 of a lower panel 482 of the base cabinet 204 behind the face frame 208 such that the cylindrical wall 420 of the module 120i and the corresponding cylindrical wall of the module 120j extend upwardly through bores in the lower panel 482. The module 120k is mounted in any suitable fashion, such as by one or more screws or other fasteners, to an upper surface 490 of the lower panel 482 while the module 120l is mounted in any suitable fashion, such as by one or more screws or other fasteners, to a side panel 492 of the base cabinet 204. While the module 120l is illustrated as being mounted completely or nearly flush against the inner surface of the face frame 208, in practice such module 120l would be mounted at an angle with respect to the face from 208 to permit ready access to the ports 474. Alternatively, the module 120l may be twisted about the cable 122f, for example, 180 degrees before mounting to the side panel 492 to allow access to the ports 474.

### INDUSTRIAL APPLICABILITY

The traces on the substrates disclosed herein are preferably of a thickness and dimension to minimize resistance to the flow of current and interconnect the various ports and cables connected thereto so that one or more loads may be conveniently connected to a source of power and controlled. Thus, for example, one or more loads, such as string(s) of LED lights, may be connected to any one or more of the ports accessible above and/or below the upper cabinet 202, inside the upper cabinet 202, below the base cabinet 204, or inside the base cabinet 204. Also, means may be provided (not shown) to limit the magnitudes of currents or power in any or all of the various branches of the illustrated circuits comprising the modules, for example, to satisfy UL class 2 requirements.

We claim:

1. An electric power distribution module, comprising:
a housing having an opening; and
a substrate disposed in the housing wherein an electrical conductor is disposed on the substrate and wherein an edge portion of the substrate proximate the opening is adapted to receive and electrically connect a connector from outside the housing through the opening to the conductor.

2. The electric power distribution module of claim 1, wherein the substrate comprises a printed circuit board and the electrical conductor comprises an electrically conductive trace.

3. The electric power distribution module of claim 1, in combination with a cable having a connector plug connected to the substrate.

4. The electric power distribution module of claim 3, wherein the connector plug includes a contact electrically coupled to the substrate.

5. The electric power distribution module of claim 3, in combination with a load coupled to the module.

6. The electric power distribution module of claim 1, in combination with a further electric power distribution module coupled to the substrate.

7. The electric power distribution module of claim 1, wherein the opening of the housing comprises a first port and the housing includes a further opening comprising a second port disposed proximate one of the edge portion and another edge portion of the substrate wherein each port is adapted to receive a connector plug in contact with the edge portion.

8. An electric power distribution module, comprising:
a housing enclosing a circuit board and having an opening that permits access to an edge of the circuit board;
a first plurality of electrically conductive traces disposed on the circuit board proximate the edge thereof wherein the traces are exposed through the opening; and
a connector plug extending through the opening and including two portions with a recess therebetween adapted to receive the edge of the circuit board and a second plurality of electrical contacts extending into the recess such that the connector plug is retained in the opening and the edge of the circuit board is disposed in the recess with the second plurality of contacts in electrical connection with the first plurality of traces.

9. The electric power distribution module of claim 8, wherein the opening comprises a first port and the housing includes a further opening comprising a second port proximate one of the edge and another edge of the circuit board and also comprising a further connector plug having two portions extending into the second port and a third plurality of electrical contact in electrical connection with a fourth plurality of electrically conductive traces disposed on the circuit board.

10. The electric power distribution module of claim 8, electrically connected to a further power distribution module by a cable having the connector plug.

11. The electric power distribution module of claim 10, wherein the further power distribution module comprises a further housing enclosing a further circuit board and having a further opening that permits access to a further plurality of electrically conductive traces disposed proximate an edge of the further circuit board.

12. The electric power distribution module of claim 11, wherein the cable includes a first end at which the connector plug is disposed and a second end opposite the first end at which a further connector plug is disposed and which is electrically connected to the further plurality of traces.

13. An electric power distribution system, comprising:
a plurality of distribution modules wherein at least one distribution module is electrically connected to another distribution module by at least one first conductor and first and second connector plugs disposed at opposite ends of the at least one first conductor and at least one of the distribution modules is adapted to be coupled to a load by at least one second conductor having a third connector plug disposed at an end of the at least one second conductor, and wherein each distribution module includes
a housing having an opening,
a circuit board disposed in the housing,
a plurality of electrically conductive traces disposed on opposite sides of the circuit board proximate the opening, wherein the opening is adapted to receive at least one of the first, second, and third conductor plugs.

14. The electric power distribution system of claim 13, disposed in at least one cabinet.

15. The electric power distribution system of claim 14, wherein each of the connector plugs includes spaced first and second portions with a recess therebetween and a plurality of contacts extending into the recess and each adapted to engage an electrically conductive trace.

16. The electric power distribution system of claim 15, wherein each of the first and second connector plugs includes pairs of opposed contacts extending into the recess and adapted to engage opposed electrically conductive contacts disposed on opposite sides of the circuit board.

17. The electric power distribution system of claim 15, wherein each of the first and second connector plugs includes three pairs of opposed contacts extending into the recess and adapted to engage three pairs of opposed electrically conductive contacts disposed on opposite sides of the circuit board and the at least one first conductor comprises six first conductors electrically coupled to the contacts.

18. The electric power distribution system of claim 17, wherein the third connector plug includes a single pair of opposed contacts extending into the recess and adapted to engage a pair of opposed electrically conductive contacts disposed on opposite sides of the circuit board and the at least one second conductor comprises two second conductors electrically coupled to the contacts.

19. The electric power distribution system of claim 18, wherein ends of the two second conductors are adapted to be connected to the load by a fourth connector plug.

20. The electric power distribution system of claim 13, wherein a source of power is coupled to at least one of the distribution modules.
